(19) United States
(12) Patent Application Publication
(10) Pub. No.: US 2023/0344952 A1
(43) Pub. Date: Oct. 26, 2023

(54) INTERPOLATION IN A COMPONENT SPACE

(71) Applicant: HEWLETT-PACKARD DEVELOPMENT COMPANY, L.P., Spring, TX (US)

(72) Inventors: Jordi Vilar Benito, Sant Cugat del Valles (ES); Jordi Arnabat Benedicto, Sant Cugat del Valles (ES); David Duran Rosich, Sant Cugat del Valles (ES)

(21) Appl. No.: 17/660,733

(22) Filed: Apr. 26, 2022

(51) Int. Cl. H04N 1/64

(52) U.S. Cl. CPC H04N 1/64

(57) ABSTRACT

In some examples, in a component space defined by a plurality of edges, a system defines a first point on a first edge of the plurality of edges, the first point dividing the first edge into a first portion in which a first component is to be used in producing an output by an output device, and a second portion in which the first component is not used in producing an output by the output device, where a first space inside the component space corresponding to the first portion is to use the first component in producing an output by the output device, and a second space inside the component space corresponding to the second portion is to not use the first component in producing an output by the output device. The system generates values of an internal node within the component space by interpolating between a first node on the first edge and a second node on a second edge of the plurality of edges, where the interpolating is along an interpolation axis based on a boundary between the first space and the second space.

### BACKGROUND

Color separation can refer to a process by which an input color image is separated into individual color components of a multi-dimensional color space, such as the CMYK (cyan, magenta, yellow, black) color space. The color components of the multi-dimensional color space are the color components used by a color printer.

### BRIEF DESCRIPTION OF THE DRAWINGS

Some implementations of the present disclosure are described with respect to the following figures.

FIG. 1 is a schematic diagram of a color separation space with 8 vertices, according to some examples.

FIG. 2 is a schematic diagram of interpolations that can be performed in a color separation space, according to some examples.

FIGS. 3A-3C are schematic diagrams of interpolations that can be performed in a color separation space, according to further examples.

FIG. 4 is a block diagram of a printing system, according to some examples.

FIG. 5 is a block diagram of a storage medium storing machine-readable instructions according to some examples.

FIG. 6 is a block diagram of system according to some examples.

FIG. 7 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

A color separation process may employ mappings between colors defined in a first color space and corresponding colors defined in a second color space. For example, the mappings may be stored in a color lookup table (CLUT) which may be accessed by the color separation process to map between the first and second color spaces.

An example approach for implementing color separation is to define transitions between multiple vertices, e.g., C (cyan), M (magenta), Y (yellow), R (red), G (green), B (blue), W (white), K (black), of a color space and then fill the interior space of the color space by interpolation. Such color separation may be encoded in the form of a CLUT.

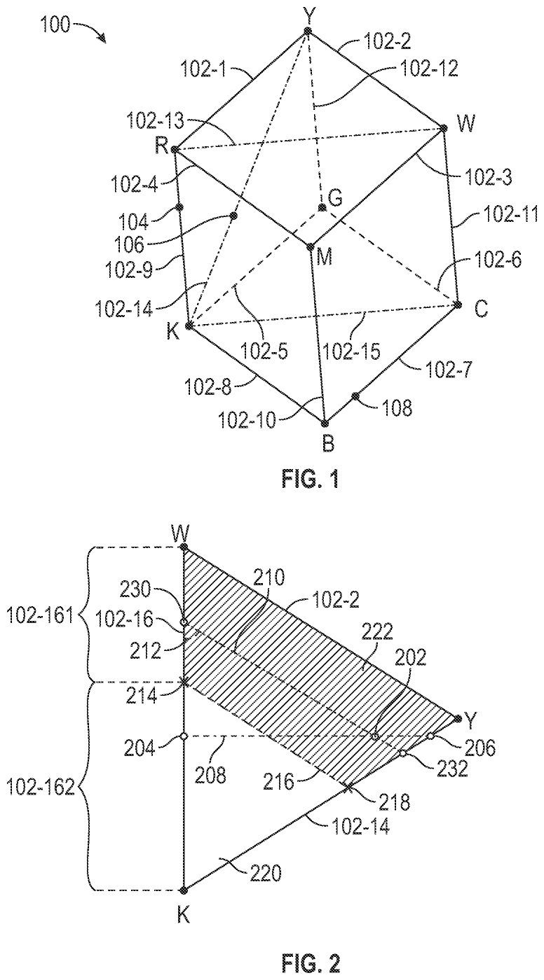

FIG. 1 shows an example of a cube representing a color separation space 100 with the foregoing vertices. A vertex of a color separation space may be a location in the color separation space where all component coordinates are either at a minimum or maximum in the color space (e.g. at either 0 or 1 when normalized). The W (white) point of a color separation space may include a set of coordinates in the color separation space, that corresponds to, or defines the color white. Similarly, the K (black) point of a color separation space may include a set of coordinates in the color separation space, that corresponds to, or defines, the color black.

As shown in FIG. 1, various edges connect the 8 vertices of the color separation space 100, including main edges 102-1 to 102-12. For example, the main edge 102-1 connects the R and Y vertices, the main edge 102-2 connects the Y and W vertices, the main edge 102-3 connects the W and M vertices, the main edge 102-4 connects the M and R vertices, and so forth.

In addition, diagonal edges can connect other vertices. As shown in FIG. 1, a diagonal edge 102-13 connects the W and R vertices, a diagonal edge 102-14 connects the Y and K vertices, and a diagonal edge 102-15 connects the K and C vertices. Although not shown in FIG. 1, a further diagonal edge can connect the K and W vertices. FIG. 2 (discussed further below) shows a diagonal edge 102-16 between the K and W vertices. In some examples, this diagonal edge 102-16 can be referred to as the “main” diagonal edge for purposes of performing interpolation to obtain color component values within the color separation space (e.g., for internal nodes of the cube representing the color separation space 100).

An “internal node” refers to a node in the color separation space 100 away from any of the edges (main edges and diagonal edges) of the color separation space 100. The internal node's location in the color separation space 100 corresponds to input color values of a point in an input color gamut. The color separation space 100 is to map the input color values of the point in the input color image to corresponding color component values of color components to be used by an output device.

Color nodes are defined along each of the edges (main edges and diagonal edges). For example, the color nodes include a color node 104 on the main edge 102-9, a color node 106 on the diagonal edge 102-14, and a color node 108 on the main edge 102-7. Each edge you can have a discrete quantity of color nodes, where the quantity of color nodes can be included in a CLUT. Each color node represents a combination of color components (e.g., colorants) that are used by an image forming device (e.g., a printing system, a display device, etc.) for producing the corresponding color represented by the color node. The combination of colorants is included in the CLUT. More specifically, each color node includes a combination of values of the different color components (e.g., C, M, Y, K) to be used to form an output by an output device.

A “printing system” can refer to either a two-dimensional (2D) printing system or a three-dimensional (3D) printing system. A 2D printing system dispenses inks of different colors onto a print medium (e.g., a paper substrate, a plastic substrate, a cloth substrate, etc.) to form an image on the print medium. A 3D printing system dispenses 3D printing agents (e.g., fusing agents, detailing agents, inks, etc.) onto parts of a 3D object that is built on a layer-by-layer basis. The 3D printing agents are dispensed onto each layer of build material used in a 3D printing process to process the layer of build material as the 3D object is successively formed.

More generally, an “output device” can refer to any device that produces an output based on use of various components, such as color components, 3D printing agents, and so forth.

A “colorant” refers to a color material (e.g., ink) that is used by a printing system to form an image on a target, such as a print substrate, a 3D part, and so forth.

To output an internal color within the color separation space 100, where an internal color corresponds to an internal node inside the color separation space 100 away from any of the main and diagonal edges, interpolation is performed based on color nodes on the edges. In other words, an internal color code is interpolated based on color component values of color nodes on various edges.

FIG. 2 is a 2D view of an example of an interpolation that can be performed. Three edges are shown in FIG. 2, including the main diagonal edge 102-16, the diagonal edge 102-14 between the W and Y vertices, and the diagonal edge 102-14 between the K and Y vertices. Note that in a 3D space such as the color separation space 100, there would be more edges involved in the interpolation.

In FIG. 2, using traditional techniques, an internal node 202 can be interpolated using a color node 204 on the main diagonal edge 102-16 and another color node 206 on the diagonal edge 102-14 along an interpolation axis 208 that is generally perpendicular to the main diagonal edge 102-16. In the 3D space, the interpolation would involve a further color node on another edge of the color space, and the interpolation axis 208 would be part of an interpolation plane.

The color node 204 can include a first set of CMYK values (values of the C, M, Y, K color components), and the color node 206 can include a second set of CMYK values. Interpolation is applied to generate the CMYK values for the internal node 202 based on the first and second sets of CMYK values. The interpolated value of each of the C, M, Y, and K components is based on the relative distances of the internal node 202 to the color nodes 204 and 206.

In some examples, interpolation may consider perceptual (in case of colorants) uniformity. In a transition between two nodes, the same linear increment in the separated components may be perceived as different in magnitude when applied at different steps in the transition. An example strategy is to interpolate considering not the linear progression of components but the apparent or effective response of those components.

For example, the perceived magnitude in change from 0% to 5% of magenta may be similar to 80% to 100% of the same ink, so an evenly distributed progression of magenta is not linear when considering the perceived effect.

An issue associated with such an interpolation approach is that large regions of the CLUT are interpolated from distant color nodes on the edges of the color space, and if those distant color nodes are unrelated, unwanted artifacts may be introduced by interpolated color nodes.

An example of an artifact includes scum dots, which are produced when an interpolated color node (generated based on interpolation derived from a first color node and a second color node) has a colorant that is not desired for producing color in a region close to the second color node. For example, for producing a color close to the K-Y edge 102-14, the interpolation based on the color node 204 on the W-K main diagonal edge 102-16 to produce the internal node 202 may use some amount of the K (black) colorant. The presence of the K colorant may be visible when trying to reproduce the color (corresponding to the internal node 202) close to the second color node 206, which results in an unwanted scum dot in the output produced by the image output device. The effect may be even more dramatic close to the W-Y edge, which is not expected to contain any K.

Thus, interpolation may generate small amounts of undesired colorants for certain internal nodes, which causes generation of visible scum dots in an output image that may be perceived by a user as unclean and of low quality. This artifact is frequently seen when small proportions of the K colorant are mixed in light colorants like Y or C.

In accordance with some implementations of the present disclosure, to reduce the presence of artifacts in an output produced by an output device, an interpolation (e.g., a linear interpolation or another type of interpolation) to derive values of color components of an internal node (e.g., the internal node 202 of FIG. 2) in a color space is along an interpolation axis (e.g., 210 in FIG. 2) that has a non-right angle 212 with respect to the main diagonal edge 102-16 (as compared to the interpolation axis 208 that is generally at a right angle with respect to the main diagonal edge 102-16).

The interpolation axis 210 has a non-zero angle with respect to the interpolation axis 208 (i.e., the interpolation axis 210 is not parallel to the interpolation axis 208).

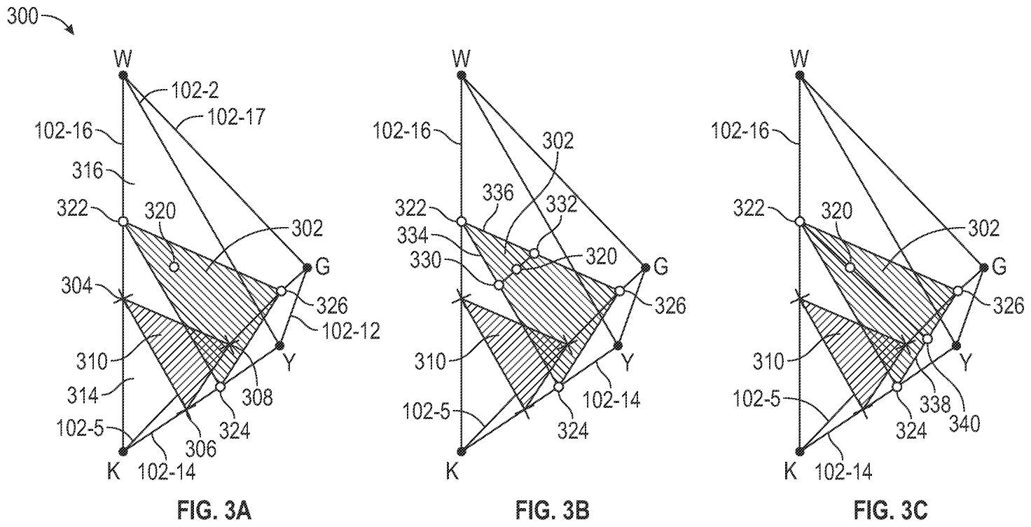

In the 3D space, the interpolation would involve a further color node on another edge of the color space, and the interpolation axis 210 would be part of an interpolation plane (depicted in FIGS. 3A-3C, as discussed further below).

In some examples, a system defines, in a component space (e.g., a color space such as the color separation space 100, or a space defining 3D printing agents to be used, etc.) having multiple edges (e.g., the main and diagonal edges shown in FIG. 1), a partition point on a first edge (e.g., a partition point 214 on the main diagonal edge 102-16). The partition point divides the first edge into a first portion in which a particular component (e.g., a colorant for a 2D printing system, or a 3D printing agent for a 3D printing system, etc.) is to be used in producing an output by an output device, and a second portion in which the particular component is not used in producing an output by the output device.

For example, the partition point 214 divides the main diagonal edge 102-16 into a first portion 102-161 in which the K colorant is not used, and a second portion 102-162 in which the K colorant is used. Stated differently, any given color node in the first portion 102-161 on the main diagonal edge 102-16 has a value of 0 for the K color component (which indicates that the K color component is not used when forming an output using color component values of the given color node), while any further color node in the second portion 102-162 on the main diagonal edge 102-16 has a non-zero value for the K color component (which indicates that the K color component is used when forming an output using color component values of the further color node).

In FIG. 2, a first color space segment 220 (non-shaded in FIG. 2) is a space in which the K color component is used when forming an output by an output device, and a second color space segment 222 (shaded in FIG. 2) is a space in which the K color component is not used when forming an output by the output device. The first color space segment 220 and the second color space segment 222 are separated by a boundary 216 that connects the partition point 214 on the main diagonal edge 102-16 to a partition point 218 on the diagonal edge 102-14 between the K and Y vertices. The partition point 218 separates the edge 102-14 into a first portion (adjacent the second color space segment 222) in which the K colorant is not used, and a second portion (adjacent the first color space segment 220) in which the K colorant is used.

The boundary 216 starts at the partition point 214 and extends in a direction to the partition point 218 on the diagonal edge 102-14. In some examples, the boundary 216 may be parallel to the edge 102-2 between the W and Y vertices; in other examples, the boundary 216 is not parallel to the edge 102-2.

The interpolation axis 210 for the interpolation to derive values of the color components of the internal node 202 in the color space is parallel to the boundary 216. In the example of FIG. 2, the interpolation along the interpolation axis 210 is based on a first color node 230 on the main diagonal edge 102-16 and a second color node 232 on the diagonal edge 102-14 (as well as another color node on another edge in the 3D space). Note that both the first color node 230 and the second color node 232 are within the second color space segment 222 that does not employ the K color component. As a result, an output produced using the interpolated color component values of the internal node 202 (as interpolated along the interpolation axis 210) would not include artifacts (e.g., scum dots) caused by the K color component.

Although FIG. 2 shows a 2D view in which the boundary 216 is represented as a line, it is noted that in a 3D space, the boundary 216 is in the form of a plane, and the first color space segment 220 and the second color space segment 222 are 3D spaces.

The plane is a plane for each tetrahedron the cube representing the color separation space 100 of FIG. 1 is split into (as discussed further below, the cube is split into six tetrahedra). That is, there is a plane for each of the ordered pairs of Y-R, R-M, M-B, B-C, C-G, G-Y, that compose a hue ring. Each pair, along with the main diagonal K-W, form a tetrahedron. All six tetrahedra cover the entire cube.

More generally, a first space (e.g., 220) inside a component space corresponds to a first portion that is to use a first component in producing an output by the output device, and a second space (e.g., 222) inside the component space corresponds to a second portion that is to not use the first component in producing an output by the output device. The system generates an internal node within the component space by interpolating between a first node on the first edge and a second node on a second edge of multiple edges of the color space, where each of the first node and the second node includes values for respective components represented by the component space, and the internal node includes interpolated values for the respective components. The interpolating is along an interpolation axis based on a boundary (e.g., the boundary 216) between the first space and the second space.

The partition points 214 and 218 in FIG. 2 represent a critical parameter, which in the example of FIG. 2 represents whether or not the K color component is used.

Although FIG. 2 shows an example of using one critical parameter to define partition points on respective edges, in further examples, more than one critical parameter can be specified. For example, for each component, a critical point on each edge can be defined, but only one per edge and per component.

FIGS. 3A-3C are 3D views of interpolations that can be performed in 3D space along an interpolation plane 302.

In some examples, the CLUT describing the color separation space, defined by a cube, can be sliced into six tetrahedra sharing the main diagonal edge 102-16. The resulting object can be seen as its topological equivalent dodecahedron. In other examples, the CLUT can be divided into 3D parts of other shapes.

FIG. 3A shows a tetrahedron 300 that is one of the six tetrahedra. In some examples, the same interpolation technique can be used for each of the six tetrahedra.

The tetrahedron 300 is defined by the main diagonal edge 102-16 and the following additional edges: the edge 102-2 between the W and Y vertices, an edge 102-17 between the W and G vertices, the edge 102-14 between the K and Y vertices, the edge 102-5 between the K and G vertices, and the edge 102-12 between the Y and G vertices.

A critical parameter defines a partition point on each of the following edges of the tetrahedron 300: 102-16, 102-14, 102-5. The partition points include a partition point 304 on the edge 102-16, a partition point 306 on the edge 102-14, and a partition point 308 on the edge 102-5.

The critical parameter can be referred to as Kₛₜₐᵣₜ, for example, which refers to a point where use of the K color component starts. In some examples, partition points representing this critical parameter may appear only on three of the six edges (the partition point 304 on the edge 102-16, the partition point 306 on the edge 102-14, and the partition point 308 on the edge 102-5). In some examples, Kₛₜₐᵣₜ may be monotonic along an edge. More generally, Kₛₜₐᵣₜ is used to define one region where K is present and a complementary region where K is absent.

A boundary plane 310 is defined by the partition points 304, 306, and 308. The boundary plane 310 separates the tetrahedron 300 into a first color space segment 314 in which the K color component is used when forming an output by an output device, and a second color space segment 316 in which the K color component is not used when forming an output by the output device.

In the example of FIG. 3A, an interpolation process is applied to find the values of the color components of an internal node 320 within the tetrahedron 300.

The interpolation process identifies an interpolation plane (containing the internal node 320 to be interpolated) that is parallel to the boundary plane. In the example of FIG. 3A, the interpolation plane is represented as 302. The interpolation plane 302 is triangularly shaped in the tetrahedron 300. More generally, the interpolation plane 302 may have a polygon shape. For example, if the position of the internal node 320 is such that the interpolation plane intersects the edge 102-12, then the interpolation plane 302 may have a different polygon shape.

The interpolation process identifies intersections of the interpolation plane 302 with the edges 102-16, 102-14, and 102-5. The interpolation plane 302 intersects the edge 102-16 at an intersection point 322, the interpolation plane 302 intersects the edge 102-14 at an intersection point 324, and the interpolation plane 302 intersects the edge 102-5 at an intersection point 326.

FIGS. 3B and 3C show two different interpolation techniques of the interpolation process.

In FIG. 3B, the interpolation process first calculates first interpolated color component values for a point 330 on a first interpolation plane edge 334 of the interpolation plane 302, and second interpolated color component values for a point 332 on a second interpolation plane edge 336 of the interpolation plane 302.

The point 330 is between the intersection points 322 and 324 along the first interpolation plane edge 334, and the point 330 is between the intersection points 322 and 326 along the second interpolation plane edge 336. The first interpolated color component values for the point 330 can be computed by performing an interpolation between sets of color component values of the respective intersection points 322 and 324, and the second interpolated color component values for the point 332 can be computed by performing an interpolation between sets of color component values of the respective intersection points 322 and 326.

After the first and second interpolated color component values for the respective points 330 and 332 are calculated, the interpolation process performs interpolation between the points 330 and 332 to compute interpolated color component values for the internal node 320.

In FIG. 3C, the interpolation process first calculates interpolated color component values for a point 340 on a third interpolation plane edge 338 of the interpolation plane 302. The point 340 is between the intersection points 324 and 326 along the third interpolation plane edge 338. The interpolated color component values for the point 340 can be computed by performing an interpolation between sets of color component values of the respective intersection points 324 and 326.

After the interpolated values for the point 340 are calculated, the interpolation process performs interpolation between the points 322 and 340 to compute interpolated color component values for the internal node 320.

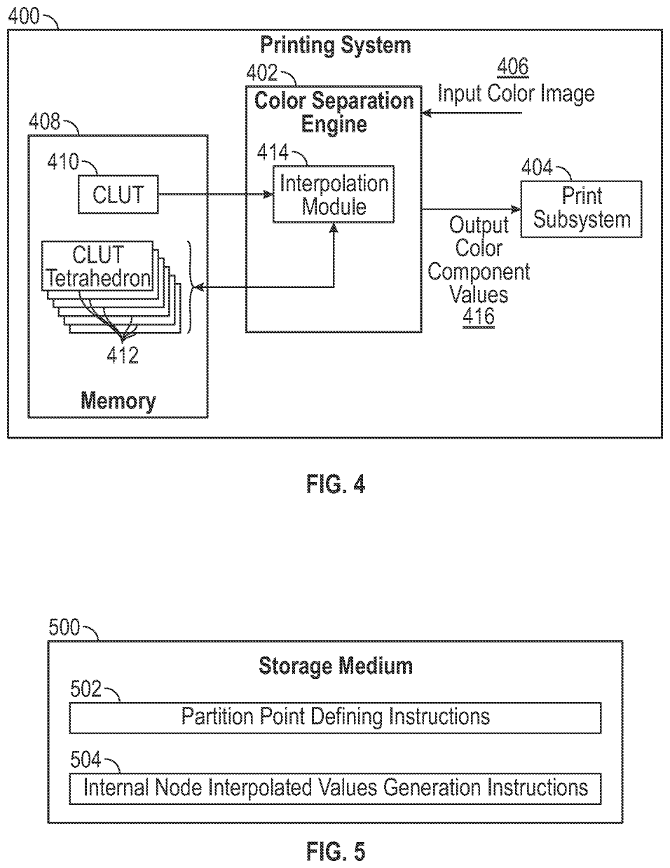

FIG. 4 is a block diagram of a printing system 400, which can be a 2D printing system for example. In other examples, techniques according to some implementations of the present disclosure can be applied in a 3D printing system or another type of output device.

The printing system 400 includes a color separation engine 402 to perform color separation, and a print subsystem 404 to produce an output image in response to an input color image 406. The output image can be formed by the print subsystem 404 on a print medium. The print subsystem 404 can include a printhead (or multiple printheads) with nozzles to dispense printing liquids (e.g., inks) onto the print medium.

As used here, an “engine” can refer to a hardware processing circuit, which can include any or some combination of a microprocessor, a core of a multi-core microprocessor, a microcontroller, a programmable integrated circuit, a programmable gate array, or another hardware processing circuit. Alternatively, an “engine” can refer to a combination of a hardware processing circuit and machine-readable instructions (software and/or firmware) executable on the hardware processing circuit.

The printing system 400 also includes a memory 408, which can be implemented using a collection of memory devices. The collection of memory devices can refer to a single memory device or multiple memory devices. Examples of memory devices can include any or some combination of the following: a dynamic random access memory (DRAM) device, a static random access memory (SRAM) device, a flash memory device, a disk-based storage device, and so forth.

The memory 408 stores a CLUT 410. The color separation engine 402 (or a different entity) can divide the CLUT 410 into six CLUT tetrahedra 412, such as discussed above. Each CLUT tetrahedron 412 can be similar to the tetrahedron 300 shown in FIG. 3A.

The CLUT tetrahedra 412 can be used by an interpolation module 414 in the color separation engine 402 to perform interpolations to compute color component values for internal nodes of the color separation space corresponding to the CLUT 410. A “module” that is part of the color separation engine 402 can refer to a portion of the hardware processing circuit of the color separation engine 402, or machine-readable instructions executable by the color separation engine 402. In other examples, the interpolation module 414 can be separate from the color separation engine 402.

The color separation engine 402 receives the input color image 406 that contains input color values. The color separation engine 402 uses the CLUT tetrahedra 412 to compute color component values for use by the print subsystem 404 in forming an image on a print medium based on the input color image 406. The interpolation module 414 computes interpolated color component values (such as according to techniques shown in FIG. 3B or 3C) for the respective input color values to produce output color component values for 16, which are provided by the color separation engine 402 to the print subsystem 404.

FIG. 5 is a block diagram of a non-transitory machine-readable or computer-readable storage medium 500 storing machine-readable instructions that upon execution cause a system (e.g., a printing system, a computer system separate from a printing system, etc.) to perform various tasks.

The machine-readable instructions include partition point defining instructions 502 to, in a component space (e.g., a color separation space, a space defining values for 3D printing agents, etc.) defined by a plurality of edges, define a first point (e.g., 214 in FIG. 2 or 304 in FIG. 3A) on a first edge of the plurality of edges. The first point divides the first edge into a first portion (e.g., 102-162 in FIG. 2) in which a first component (e.g., a colorant of a printing system, a 3D printing agent of a 3D printing system, etc.) is to be used in producing an output by an output device, and a second portion (e.g., 102-161 in FIG. 2) in which the first component is not used in producing an output by the output device. A first space (e.g., 220 in FIG. 2 or 314 in FIG. 3A) inside the component space corresponding to the first portion is to use the first component in producing an output by the output device, and a second space (e.g., 222 in FIG. 2 or 316 in FIG. 3A) inside the component space corresponding to the second portion is to not use the first component in producing an output by the output device.

The machine-readable instructions include internal node interpolated values generation instructions 504 to generate values of an internal node within the component space by interpolating between a first node on the first edge and a second node on a second edge of the plurality of edges, where each of the first node and the second node includes values for respective components represented by the component space, and the internal node includes interpolated values for the respective components, and the interpolated values for use in producing an output by the output device. The interpolating is along an interpolation axis (e.g., 210 in FIG. 2 or 302 in FIGS. 3A-3C) based on a boundary (e.g., 216 in FIG. 2 or 310 in FIGS. 3A-3C) between the first space and the second space.

In some examples, the interpolation axis is parallel to the boundary between the first space and the second space.

In some examples, the component space is a color separation space, and the plurality of edges include edges between vertices representing different colors of the color separation space.

In some examples, each vertex of the vertices of the color space represents a primary color (e.g., C, M, Y, K) or a secondary color (e.g., R, G, B). A primary color can be directly produced using a colorant of the output device, while a secondary color is produced based on a combination of colorants of the output device.

In some examples, the plurality of edges include edges between vertices of the component space, and wherein each vertex of the vertices represents a respective liquid agent used in a 3D printing process.

In some examples, the first point divides the first edge into the first portion in which a first liquid agent is used in producing a portion of a 3D object by the output device, and the second portion in which the first liquid agent is not used in producing a portion of the 3D object output by the output device.

In some examples, the machine-readable instructions divide the component space into a plurality of tetrahedra, and employ an interpolation technique for each respective tetrahedron of the plurality of tetrahedra.

In some examples, the interpolation axis is in an interpolation plane within a first tetrahedron of the plurality of tetrahedra, and the interpolation plane is parallel to the boundary between the first space and the second space.

In some examples, the interpolation plane is parallel to a boundary plane (e.g., 310 in FIG. 3A) defined by the first point on the first edge, a second point on a second edge of the plurality of edges, and a third point on a third edge of the plurality of edges. In some examples, the boundary is in the boundary plane.

In some examples, the second point divides the second edge into a first portion in which a second component is to be used in producing an output by the output device, and a second portion in which the second component is not used in producing an output by the output device, and the third point divides the third edge into a first portion in which a third component is to be used in producing an output by the output device, and a second portion in which the third component is not used in producing an output by the output device.

The first component, the second component, and the third component can be the same component or different components.

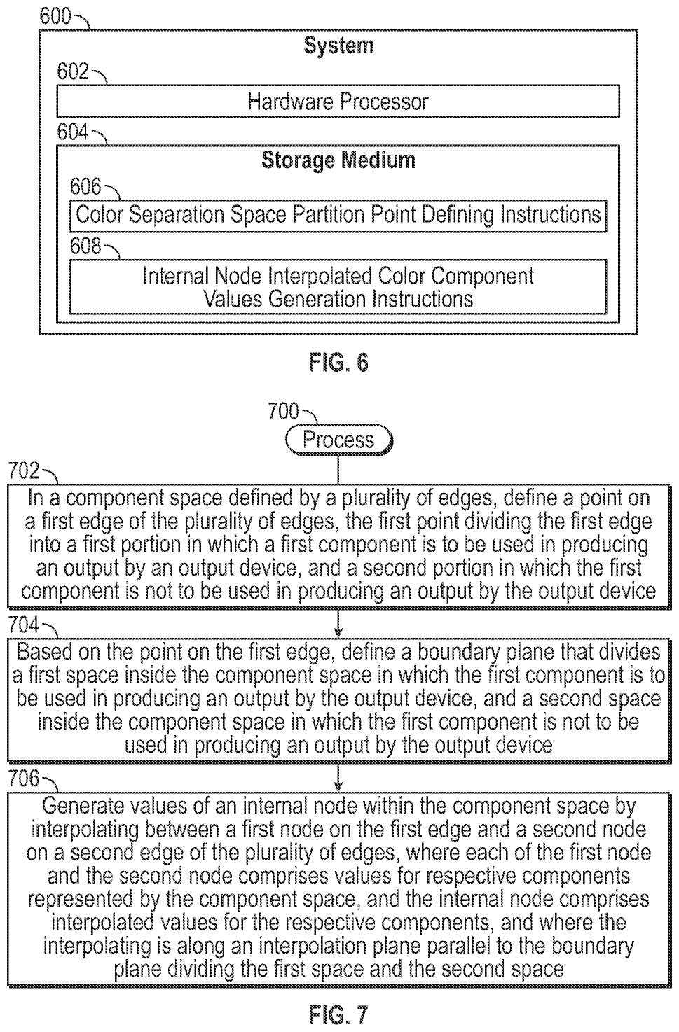

FIG. 6 is a block diagram of a system 600 according to some examples. The system 600 can be a printing system, a computer system separate from a printing system, and so forth.

The system 600 includes a hardware processor 602 (or multiple hardware processors). A hardware processor can include a microprocessor, a core of a multi-core microprocessor, a microcontroller, a programmable integrated circuit, a programmable gate array, or another hardware processing circuit.

The system 600 includes a storage medium 604 storing machine-readable instructions executable on the hardware processor 602 to perform various tasks. Machine-readable instructions executable on a hardware processor can refer to the instructions executable on a single hardware processor or the instructions executable on multiple hardware processors.

The machine-readable instructions in the storage medium 604 include color separation space partition point defining instructions 606 to, in a color separation space defined by a plurality of edges, define a point on a first edge of the plurality of edges, the first point dividing the first edge into a first portion in which a first colorant is to be used in producing an output by an output device, and a second portion in which the first colorant is not used in producing an output by the output device. A first space inside the color separation space corresponding to the first portion is to use the first colorant in producing an output by the output device, and a second space inside the color separation space corresponding to the second portion is to not use the first colorant in producing an output by the output device.

The machine-readable instructions in the storage medium 604 include internal node interpolated color component values generation instructions 608 to generate values of an internal node within the color space by interpolating between a first node on the first edge and a second node on a second edge of the plurality of edges, where each of the first node and the second node includes values for respective colorants represented by the color separation space, and the internal node includes interpolated values for the respective colorants. The interpolating is along an interpolation axis based on a boundary between the first space and the second space.

In some examples, the plurality of edges include edges between vertices of the color separation space, the first edge connects a first vertex of the vertices and a second vertex of the vertices, the first vertex represents white, the second vertex represents black, and where the interpolation direction has a non-right angle with respect to the first edge.

FIG. 7 is a flow diagram of a process 700 that can be performed by a system including a hardware processor, according to some examples.

The process 700 includes, in a component space defined by a plurality of edges, defining (at 702) a point on a first edge of the plurality of edges, the first point dividing the first edge into a first portion in which a first component is to be used in producing an output by an output device, and a second portion in which the first component is not to be used in producing an output by the output device.

The process 700 includes, based on the point on the first edge, defining (at 704) a boundary plane that divides a first space inside the component space in which the first component is to be used in producing an output by the output device, and a second space inside the component space in which the first component is not to be used in producing an output by the output device.

The process 700 includes generating (at 706) values of an internal node within the component space by interpolating between a first node on the first edge and a second node on a second edge of the plurality of edges, where each of the first node and the second node comprises values for respective components represented by the component space, and the internal node comprises interpolated values for the respective components, and where the interpolating is along an interpolation plane parallel to the boundary plane dividing the first space and the second space.

A storage medium (e.g. 500 in FIG. 5 or 604 in FIG. 6) can include any or some combination of the following: a semiconductor memory device such as a dynamic or static random access memory (a DRAM or SRAM), an erasable and programmable read-only memory (EPROM), an electrically erasable and programmable read-only memory (EEPROM) and flash memory or other type of non-volatile memory device; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A non-transitory machine-readable storage medium comprising instructions that upon execution cause a system to:
in a component space defined by a plurality of edges, define a first point on a first edge of the plurality of edges, the first point dividing the first edge into a first portion in which a first component is to be used in producing an output by an output device, and a second portion in which the first component is not used in producing an output by the output device, wherein a first space inside the component space corresponding to the first portion is to use the first component in producing an output by the output device, and a second space inside the component space corresponding to the second portion is to not use the first component in producing an output by the output device; and
generate values of an internal node within the component space by interpolating between a first node on the first edge and a second node on a second edge of the plurality of edges, wherein each of the first node and the second node comprises values for respective components represented by the component space, and the internal node comprises interpolated values for the respective components, the interpolated values for use in producing an output by the output device,
wherein the interpolating is along an interpolation axis based on a boundary between the first space and the second space.

2. The non-transitory machine-readable storage medium of claim 1, wherein the interpolation axis is parallel to the boundary between the first space and the second space.

3. The non-transitory machine-readable storage medium of claim 1, wherein the component space comprises a color separation space, and the plurality of edges comprise edges between vertices representing different colors of the color separation space.

4. The non-transitory machine-readable storage medium of claim 3, wherein the first point divides the first edge into the first portion in which a first colorant is used in producing a color output by the output device, and the second portion in which the first colorant is not used in producing a color output by the output device.

5. The non-transitory machine-readable storage medium of claim 3, wherein each vertex of the vertices of the color separation space represents a primary color or a secondary color.

6. The non-transitory machine-readable storage medium of claim 1, wherein the plurality of edges comprise edges between vertices of the component space, and wherein each vertex of the vertices represents a respective liquid agent used in a three-dimensional (3D) printing process.

7. The non-transitory machine-readable storage medium of claim 6, wherein the first point divides the first edge into the first portion in which a first liquid agent is used in producing a portion of a 3D object by the output device, and the second portion in which the first liquid agent is not used in producing a portion of the 3D object output by the output device.

8. The non-transitory machine-readable storage medium of claim 1, wherein the instructions upon execution cause the system to:
divide the component space into a plurality of tetrahedra; and
employ an interpolation technique for each respective tetrahedron of the plurality of tetrahedra.

9. The non-transitory machine-readable storage medium of claim 8, wherein the interpolation axis is in an interpolation plane within a first tetrahedron of the plurality of tetrahedra, and the interpolation plane is parallel to the boundary between the first space and the second space.

10. The non-transitory machine-readable storage medium of claim 9, wherein the interpolation plane is parallel to a boundary plane defined by the first point on the first edge, a second point on the second edge of the plurality of edges, and a third point on a third edge of the plurality of edges.

11. The non-transitory machine-readable storage medium of claim 10, wherein the boundary is in the boundary plane.

12. The non-transitory machine-readable storage medium of claim 10, wherein the second point divides the second edge into a first portion in which a second component is to be used in producing an output by the output device, and a second portion in which the second component is not used in producing an output by the output device, and
wherein the third point divides the third edge into a first portion in which a third component is to be used in producing an output by the output device, and a second portion in which the third component is not used in producing an output by the output device.

13. A system comprising:
a processor; and
a non-transitory storage medium storing instructions executable on the processor to:
in a color separation space defined by a plurality of edges, define a point on a first edge of the plurality of edges, the point dividing the first edge into a first portion in which a first colorant is to be used in producing an output by an output device, and a second portion in which the first colorant is not used in producing an output by the output device, wherein a first space inside the color separation space corresponding to the first portion is to use the first colorant in producing an output by the output device, and a second space inside the color separation space corresponding to the second portion is to not use the first colorant in producing an output by the output device; and
generate values of an internal node within the color separation space by interpolating between a first node on the first edge and a second node on a second edge of the plurality of edges, wherein each of the first node and the second node comprises values for respective colorants represented by the color separation space, and the internal node comprises interpolated values for the respective colorants,
wherein the interpolating is along an interpolation axis based on a boundary between the first space and the second space.

14. The system of claim 13, wherein the plurality of edges comprise edges between vertices of the color separation space, the first edge connects a first vertex of the vertices and a second vertex of the vertices, the first vertex represents white, the second vertex represents black, and wherein the interpolation axis has a non-right angle with respect to the first edge.

15. A method performed by a system comprising a hardware processor, comprising:
in a component space defined by a plurality of edges, define a point on a first edge of the plurality of edges, the point dividing the first edge into a first portion in which a first component is to be used in producing an output by an output device, and a second portion in which the first component is not to be used in producing an output by the output device;
based on the point on the first edge, define a boundary plane that divides a first space inside the component space in which the first component is to be used in producing an output by the output device, and a second space inside the component space in which the first component is not to be used in producing an output by the output device; and
generate values of an internal node within the component space by interpolating between a first node on the first edge and a second node on a second edge of the plurality of edges, wherein each of the first node and the second node comprises values for respective components represented by the component space, and the internal node comprises interpolated values for the respective components,
wherein the interpolating is along an interpolation plane parallel to the boundary plane dividing the first space and the second space.
